(19) United States
(12) Patent Application Publication
(10) Pub. No.: US 2021/0302036 A1
(43) Pub. Date: Sep. 30, 2021

(54) SENSOR MOUNTING ASSEMBLY FOR A CLIMATE CONTROLLER AND METHOD

(71) Applicant: Carrier Corporation, Jupiter, FL (US)

(72) Inventors: Brian W. Eicher, Fort Wayne, IN (US); Keith David Heigl, Winamac, IN (US)

(21) Appl. No.: 16/328,569

(22) PCT Filed: Aug. 14, 2017
(86) PCT No.: PCT/US2017/046687

§ 371 Date: Feb. 26, 2019

Related U.S. Application Data
(60) Provisional application No. 62/380,067, filed on Aug. 26, 2016.

(51) Int. Cl. F24F 11/00; G05D 23/19; G05D 22/02

(52) U.S. Cl. CPC F24F 11/0008; F24F 2110/10; G05D 22/02; G05D 23/1902

(57) ABSTRACT

A climate controller includes a housing defining an interior cavity and having an outer surface and an inner surface. Also included is a circuit board disposed within the interior cavity of the housing. Further included is a sensor mounting assembly that includes a mounting retainer operatively coupled to the inner surface of the housing. The sensor mounting assembly also includes a circuit connector in fixed engagement with the mounting retainer and electrically connected to the circuit board. The sensor mounting assembly further includes a sensor mounted to the circuit connector.

### BACKGROUND

The embodiments herein relate to climate controllers and, more particularly, to a sensor mounting assembly for such controllers.

Generally, comfort systems are controlled by a wall mounted thermostat. A modern wall mounted thermostat typically includes a display, a key pad and/or touch screen, including interactive input devices for programming the thermostat or for manually adjusting the air temperature in a space for which the thermostat controls the comfort levels.

In wall controls (i.e., thermostats), it is difficult to isolate the internal heating of the thermostat from a sensor (e.g., temperature, humidity, etc.) that is located on a circuit board. In some cases, a correction compensation must be added to the software to show the correct condition (e.g., temperature, humidity, etc.).

### BRIEF DESCRIPTION

According to one embodiment, a climate controller includes a housing defining an interior cavity and having an outer surface and an inner surface. Also included is a circuit board disposed within the interior cavity of the housing. Further included is a sensor mounting assembly that includes a mounting retainer operatively coupled to the inner surface of the housing. The sensor mounting assembly also includes a circuit connector in fixed engagement with the mounting retainer and electrically connected to the circuit board. The sensor mounting assembly further includes a sensor mounted to the circuit connector.

In addition to one or more of the features described above, or as an alternative, further embodiments may include that the mounting retainer is formed of plastic.

In addition to one or more of the features described above, or as an alternative, further embodiments may include that the mounting retainer comprises a slot dimensioned to receive the circuit connector therein.

In addition to one or more of the features described above, or as an alternative, further embodiments may include that the slot is defined by a first retaining wing and a second retaining wing, each retaining wing extending from a base portion of the mounting retainer.

In addition to one or more of the features described above, or as an alternative, further embodiments may include that the circuit connector comprises a flex circuit trace.

In addition to one or more of the features described above, or as an alternative, further embodiments may include that the circuit connector is electrically connected to the circuit board with a flexible connector of the circuit board.

In addition to one or more of the features described above, or as an alternative, further embodiments may include that the sensor is disposed proximate a vent of the housing.

In addition to one or more of the features described above, or as an alternative, further embodiments may include that the housing is formed of plastic.

In addition to one or more of the features described above, or as an alternative, further embodiments may include that the sensor comprises a temperature sensor.

In addition to one or more of the features described above, or as an alternative, further embodiments may include that the sensor comprises a humidity sensor.

In addition to one or more of the features described above, or as an alternative, further embodiments may include that the sensor is not in direct contact with the circuit board.

According to another embodiment, a method of thermally isolating a sensor of a climate controller is provided. The method includes coupling a mounting retainer to an inner surface of a housing. The method also includes engaging a circuit connector to the mounting retainer and electrically connecting the circuit connector to a circuit board disposed within an interior cavity of the housing. The method further includes mounting a sensor to the circuit connector.

In addition to one or more of the features described above, or as an alternative, further embodiments may include electrically connecting the sensor to the circuit board with the circuit connector, the circuit connector comprising a flex circuit trace.

In addition to one or more of the features described above, or as an alternative, further embodiments may include positioning the sensor proximate a vent of the housing.

In addition to one or more of the features described above, or as an alternative, further embodiments may include that the sensor is positioned to not be in contact with the circuit board.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a perspective, partially disassembled view of a climate controller having a sensor mounting assembly.

### DETAILED DESCRIPTION

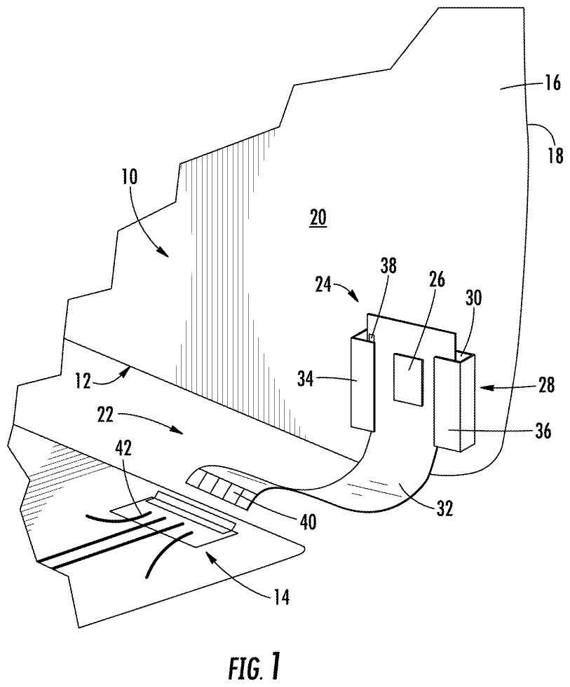

Referring to FIG. 1, a portion of a climate controller 10 is generally illustrated. In particular, a portion of a housing 12 and a circuit board 14 are shown. The circuit board 14 is rotated approximately 90 degrees from an assembled orientation for illustrative purposes. The embodiments of the climate controller 10 disclosed herein are suitable for several applications related to residential or commercial HVAC systems. Additionally, the climate controller 10 may be employed in vehicles, including transport vehicles, such as climate controlled trailers or the like. These examples are merely a few examples of applications that may benefit from the embodiments disclosed herein.

The housing 12 includes at least one wall 16 having an outer surface 18 and an inner surface 20. The inner surface 20 of one or more housing walls define an interior cavity 22 that is suitable for housing components that facilitate operation of the climate controller 10, including the circuit board 14 which is disposed therein. The housing 12 is formed of plastic or the like in some embodiments.

A sensor mounting assembly 24 is provided to avoid direct mounting of a sensor 26 to the circuit board 14. Advantageously, by ensuring that the sensor 26 is not in direct contact with the circuit board 14, the sensor 26 is thermally isolated from the heat generated by the power of the electronic components of the circuit board 14 during operation. The sensor 26 is a temperature and/or humidity sensor that detects a condition of the ambient environment. Avoiding heat transfer from the circuit board 14 allows the sensor 26 to provide a more accurate reading of the surrounding environment without the need for compensating corrections in software of the climate controller 10. Additionally, thermal isolation of the sensor 26 relative to the circuit board 14 provides more positional flexibility for the sensor 26, as the cooling effects of a housing vent are less critical.

The sensor mounting assembly 24 includes a mounting retainer 28 operatively coupled to the inner surface 20 of the housing wall 16. The mounting retainer 28 defines a slot 30 for receiving a circuit connector 32 therein in a fixed manner. In the illustrated embodiment, the mounting retainer 28 includes a first retaining wing 34 and a second retaining wing 36, each extending from a base portion 38 of the mounting retainer 28. In some embodiments, the mounting retainer 28 comprises multiple components, while other embodiments consist of a single, integrally formed component. The mounting retainer 28 may be fixed to the inner surface 20 of the housing wall 16 in any suitable manner, including with mechanical fasteners. Alternatively, the mounting retainer 28 may be integrally formed with the housing wall 16. The mounting retainer 28 is formed of plastic or the like in some embodiments.

The circuit connector 32 is sized to be snugly retained within the slot 30 of the mounting retainer 28. The circuit connector 32 comprises a flex circuit trace in some embodiments, but it is to be appreciated that alternative contemplated electrical circuit connectors may be suitable in some applications. The circuit connector 32 is electrically connected to the circuit board 14 with a connector end 40 that connects with a flex connector 42 of the circuit board 14.

The sensor 26 is mounted to the circuit connector 32, thereby maintaining electrical connection to the circuit board 26 while thermally isolating the sensor 26 from the circuit board 14. The mounting retainer 28, and therefore the sensor 26, are located proximate a vent of the housing wall 16 in some embodiments to enhance cooling of the sensor 26 and to obtain more accurate readings of the environment condition to be detected by the sensor 26. In some embodiments, the sensor 26 faces the vent.

Advantageously, the sensor 26 is thermally isolated from the circuit board 14 and design flexibility is enhanced by allowing the sensor to be located in regions other than a bottom corner of the circuit board 14, as is often required when the sensor 26 is mounted to the circuit board 14.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A climate controller comprising:
a housing defining an interior cavity and having an outer surface and an inner surface;
a circuit board disposed within the interior cavity of the housing; and
a sensor mounting assembly comprising:
a mounting retainer operatively coupled to the inner surface of the housing;
a circuit connector in fixed engagement with the mounting retainer and electrically connected to the circuit board; and
a sensor mounted to the circuit connector.

2. The climate controller of claim 1, wherein the mounting retainer is formed of plastic.

3. The climate controller of claim 1, wherein the mounting retainer comprises a slot dimensioned to receive the circuit connector therein.

4. The climate controller of claim 3, wherein the slot is defined by a first retaining wing and a second retaining wing, each retaining wing extending from a base portion of the mounting retainer.

5. The climate controller of claim 1, wherein the circuit connector comprises a flex circuit trace.

6. The climate controller of claim 1, wherein the circuit connector is electrically connected to the circuit board with a flexible connector of the circuit board.

7. The climate controller of claim 1, wherein the sensor is disposed proximate a vent of the housing.

8. The climate controller of claim 1, wherein the housing is formed of plastic.

9. The climate controller of claim 1, wherein the sensor comprises a temperature sensor.

10. The climate controller of claim 1, wherein the sensor comprises a humidity sensor.

11. The climate controller of claim 1, wherein the sensor is not in direct contact with the circuit board.

12. A method of thermally isolating a sensor of a climate controller comprising:
coupling a mounting retainer to an inner surface of a housing;
engaging a circuit connector to the mounting retainer and electrically connecting the circuit connector to a circuit board disposed within an interior cavity of the housing; and
mounting a sensor to the circuit connector.

13. The method of claim 12, further comprising electrically connecting the sensor to the circuit board with the circuit connector, the circuit connector comprising a flex circuit trace.

14. The method of claim 12, further comprising positioning the sensor proximate a vent of the housing.

15. The method of claim 12, wherein the sensor is positioned to not be in contact with the circuit board.
